(19) United States
(12) Patent Application Publication
(10) Pub. No.: US 2009/0282370 A1
(43) Pub. Date: Nov. 12, 2009

(54) GRAPHICAL USER INTERFACE FOR DATA ENTRY

(75) Inventors: Michael J. Rainwater, Frisco, TX (US); Aaron D. Richardson, Dallas, TX (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/115,703

(22) Filed: May 6, 2008

(51) Int. Cl. G06F 3/048

(52) U.S. Cl. 715/863

(57) ABSTRACT

A graphical user interface is provided for facilitating entry of data into a telephone, personal digital assistant or other computing device having a touch-sensitive input component (e.g., a touch screen). The interface includes multiple initial contact areas associated with different input (e.g., characters, numerical values, commands), a home area and spokes positioned between the initial contact areas and the home area. The interface is manipulated using gestures. A data input gesture begins by touching in or near an initial contact area and moving to or toward the home area, generally in proximity to the corresponding spoke. Other illustrative gestures include tracing directly from one initial contact area to another (e.g., to add the corresponding data values), performing a “throwing” gesture out of the home area (e.g., to delete the last input), gesturing backward/forward in the home area (e.g., to move backward/forward through a series of fields), etc.

### BACKGROUND

This invention relates to the field of computing devices. More particularly, a graphical user interface is provided for entering data into a computing device, and methods for using the graphical user interface.

Many communication and computing devices include touch screens or touch pads for inputting data. Touch screens are very different from traditional input components that have multiple independent physically manipulable controls (e.g., keys, buttons)—such as keyboards, mice and keypads.

Instead of separate physical controls for entering data, a touch screen allows input to be entered directly on a display component on which information is displayed. A touch pad operates similarly, but is usually connected to the device as a peripheral accessory and does not comprise a display. Different regions or portions of the surface of the touch screen or touch pad may correspond to different data patterns (e.g., characters), but the tactile experience may be similar or identical for all patterns.

Many devices that employ touch screens (or touch pads) are portable and the input surfaces are usually relatively small. Further, because each character of input entered on a touch screen usually corresponds to a single location-specific touch of a finger, stylus or other tool, the size and/or configuration of the input area can make data entry cumbersome and slow.

For example, a user may accidentally touch one input area when meaning to contact a different one, or the size of the input tool (e.g., a fingertip, a stylus) may cause a touch to cover multiple areas and therefore result in extraneous input. Therefore, it can be difficult for an adult human to easily, accurately and rapidly input a string of data.

In addition to errors attributable to the small size of a touch screen or touch pad and its small input areas, the input process can become even more error-prone and less efficient due to movement of the device, the operator or both.

### SUMMARY

In one embodiment of the invention, a graphical user interface and methods of using the interface are provided for facilitating entry of data into a device in which input is received via a touch-sensitive surface, rather than via independent physical elements such as keys or buttons. In particular, the device includes (or is connected to) a touch screen or comparable component, and may be a telephone, MP3 player, personal digital assistant, and/or other computing device now known or hereafter developed.

In some embodiments of the invention, data and/or control commands are entered with gestures that comprise more than a simple touch or tap. For example, entering a given digit may entail pressing a desired initial contact area with a tool (e.g., a finger, a stylus) and then moving the tool in a particular direction from the area of initial contact (e.g., toward a final contact area).

Different input may be associated with different combinations of initial contact area(s), movement direction(s) and final contact area(s). For example, gestures corresponding to different input may end at the same final contact area, but begin at different initial contact areas and/or traverse different paths of movement.

In some embodiments of the invention, the graphical user interface is primarily configured for the entry of numeric data. Other embodiments are configured for the entry of alphanumeric and/or other types of data.

### DESCRIPTION OF THE FIGURES

FIG. 1 depicts a graphical user interface configured to facilitate data entry in accordance with an embodiment of the present invention.

FIG. 2 depicts a graphical user interface configured to facilitate data entry in accordance with an embodiment of the present invention.

FIG. 3 is a diagram illustrating regions of tolerance for receiving a user gesture on a graphical user interface configured to facilitate data entry, according to an embodiment of the invention.

FIG. 4 is a flowchart illustrating one method of facilitating data entry via a graphical user interface configured to facilitate data entry in accordance with an embodiment of the invention.

FIG. 5 graphically represents the selection of one region of certainty over another when a gesture begins and/or ends in a region of uncertainty adjacent to two regions of certainty.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown, but is to be accorded the widest scope consistent with the principles and features disclosed herein.

In one embodiment of the invention, a graphical user interface is provided for facilitating the entry of data into a device having a touch screen or other touch-sensitive component that comprises a display, along with methods of using the interface. Devices in which an embodiment of the invention may be implemented include telephones, MP3 players, personal digital assistants and/or other communication and computing devices now known or hereafter developed. The touch-sensitive surface may be integral to the device or may be coupled to it as a peripheral accessory.

In another embodiment of the invention, the touch-sensitive surface may be a separate component from the display on which the graphical user interface is presented. For example, the interface may be presented on a standard display, and a cursor or other pointer on the display may be manipulated via the touch-sensitive surface (e.g., a touch pad).

In an embodiment of the invention, data are input via the touch-sensitive surface using gestures that may comprise more than a simple touch, poke or tap. For example, one data entry gesture may comprise touching within a certain initial contact area with a finger or other tool and dragging or moving the tool in a particular direction. In another embodiment the gesture may require the dragging movement to terminate within or near a particular “home” or final contact area.

In some embodiments of the invention, entry of multiple different data values may commence with gestures originating from a single initial contact area or ending in a single home area. In this embodiment, movement of the tool along a path from the initial contact area and/or toward the home area disambiguates between the different possible values. Because a gesture incorporates movement that can be tracked, and because a combination of a touch and a movement can provide greater certainty regarding the user's intention, data entry can be much more accurate than methods that rely solely upon single touches.

In particular, a single touch of a tool may be attributable to multiple different points or locations, particularly locations having little physical separation, and therefore a user's intended point of contact may differ from his or her actual point of contact. However, requiring movement in some specific or general direction allows the user to correct any initial error in the tool's placement and, in combination with identification of the initial or final contact area, reduces ambiguities between multiple input patterns.

In different embodiments of the invention, different devices and/or user interfaces may be employed with a method described herein. For example, the configuration of a user interface displayed on a touch screen for receiving a user's gestures may differ depending on the device, the size or shape of the touch screen, the resolution and the number of colors that can be displayed, the purpose of the input, the type of data to be input (e.g., numeric, alphanumeric), etc.

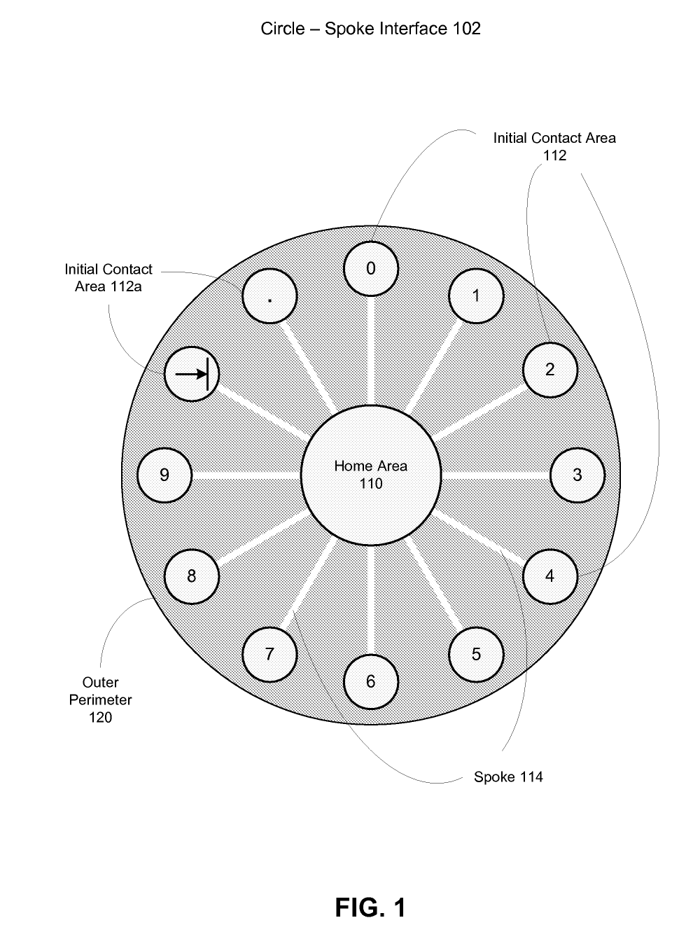

FIG. 1 depicts a user interface for facilitating data entry according to one embodiment of the invention. Circle-spoke interface 102 is so named because the interface is generally circular in shape and employs spokes as guides for users' data entry gestures. As will be seen, the use of spokes as guides for gestures between initial contact areas and a home area is common to multiple embodiments of the invention.

Interface 102 of FIG. 1 may be programmed into an application, applet or utility program, or may be installed as an add-on. The interface is displayed on a touch screen when numeric (or other) input is required, such as when a user is to fill out a data field, input a telephone number, perform a mathematical operation, select from a list of menu options, etc.

Interface 102 includes home area 110, where some gestures begin or end. The interface also includes any number of initial contact areas 112 and spokes 114 between the initial contact areas and home area 110. Spokes 114 may or may not contact either or both initial contact areas 112 and home area 110. Although interface 102 includes outer perimeter 120 in the shape of a circle in FIG. 1, the shape of the user interface (and elements thereof) may vary from one embodiment of the invention to another without exceeding the scope of the invention.

In one method of using interface 102 to enter data, for each data entry (e.g., each character, each command, each selection from a set of multiple options) a user or operator makes initial contact on or near an initial contact area 112. Then, without removing his or her tool (e.g., finger, stylus) from the touch screen, he or she moves it toward home area 110, preferably along or near the corresponding spoke 114. When the tool approaches, reaches or is lifted from home area 110, the data value associated with the initial contact area is entered into the application or utility. In different implementations, different degrees of variation from the initial contact area, spoke and home area are tolerable.

In the embodiment of the invention illustrated in FIG. 1, the initial contact areas correspond to numeric digits 0 through 9 and two additional inputs (i.e., TAB and period characters in interface 102). In other embodiments, initial contact areas 112a may correspond to other input and a different number of initial contact areas may be presented and associated with any desired data characters, commands or other input. If a particular value associated with an initial contact area is illegal or inappropriate in a given circumstance (e.g., in a particular data field), it may be deactivated with or without any visual clue being provided (e.g., the initial contact area may be grayed out or may have a different size or color), or may be replaced with other data.

Any or all of the values associated with initial contact areas may be programmable by a user or the application that presents the interface. Different numerals, characters, words, phrases, commands or other options may therefore be assigned to the initial contact areas depending on the active application, data field or some other factor. For example, when used to input a telephone number, initial contact areas 112a may be associated with the “*” and “#” keys. When used to perform a calculation, additional initial contact areas may be displayed to allow particular mathematical operations (e.g., +, −, /, *). As another example, a user may configure one or more initial contact areas (e.g., initial contact areas 112a) for commands or controls that he or she uses frequently.

Depending on the application or utility that presents interface 102 to receive data, the data value entered due to a particular gesture may complete the necessary input (e.g., if only a single digit of input is required) or may be followed by another gesture (e.g., in order to enter the next digit of input).

In other words, interface 102 may be used to input any number of sequential characters or digits, depending on what the input is to be used for. To enter a telephone number, for example, a user will perform multiple gestures to enter the 7 digits (or 10 digits including area code).

As shown in FIG. 1, one of the initial contact areas 112a may be programmed as a TAB key to facilitate movement through a series of data fields. Thus, after a series of gestures corresponding to one sequence of input, a gesture for entering the TAB command may be performed to move to a next data field or, alternatively, the application may automatically advance after receiving the expected number of digits.

In one embodiment of the invention, after a character is entered via a gesture, and the tool used to enter the gesture is removed from the surface of the screen, that character may be repeated by tapping in home area 110.

Other special gestures may be used to perform other operations. For example, moving a tool across home area 110 in a generally right to left direction may be interpreted as a “backspace” or “previous field” command. Conversely, moving the tool across home area 110 in a generally left to right direction may be interpreted as “tab” or “next field” or “enter.” Upward or downward gestures may be associated with scrolling or paging up or down.

Various predetermined gestures may therefore be associated with an interface in different implementations. Further, in one embodiment of the invention a user may be able to record or define a custom gesture or macro to perform a particular operation or enter a particular value.

Moving the tool outward from home area 110 toward the last digit entered may be interpreted as a “delete” command to delete that digit (e.g., the gesture mimics “throwing” the last digit out of the home area). The user may or may not need to gesture all the way from the home area to the digit—gesturing outward in the general direction of the digit may be sufficient. Alternatively, a deletion (or “backspace”) command may also be assumed if the tool is moved outward from the home area in any direction, not just toward the previous digit.

One skilled in the art will recognize that the various elements of interface 102 (e.g. initial contact areas, spokes, home area) and gestures involving those elements can be configured in a multitude of permutations in different embodiments of the invention. For example, a basic data entry gesture may be reversed, so as to start within (or near) home area 110 and proceed to or toward a contact area 112.

In one implementation of circle-spoke interface 102, consecutive digits are entered separately via multiple separate gestures as described above. Each gesture commences in or near an initial contact area 112, proceeds along or in the general direction of the corresponding spoke 114, and terminates in or near home area 110.

In an alternative embodiment of the invention, movement directly between initial contact areas may be permitted and interpreted as invoking an alternative mode of operation to add the corresponding digits. The special addition mode of operation may be detected when the user deviates from the basic data entry gesture described above (i.e., when he does not gesture from an initial contact area toward home area 110 and then lift the tool).

For example, gesturing directly from one initial contact area to another will involve a path of movement easily discernable from the basic data entry gesture. Even paths of movement through home area 110 (e.g., to add 2 and 8 in circle-spoke interface 102) can be differentiated because the user does not lift the tool after reaching the home area.

Illustratively, when this special mode of operation is detected or when it is possible (e.g., when the tool is situated in or near an initial contact area), temporary spokes from the current initial contact area to the other initial contact areas may be displayed (e.g., with a color, weight or other attribute differing from spokes 114). These temporary spokes can help guide gestures to the other digits. To add a digit to itself, a user may make a generally circular gesture out of the digit's initial contact area and back to the same area.

Multi-digit numerals can also be added, by gesturing for addition of each numeral's corresponding digits in sequence, starting with the ones, then the tens, the hundreds and so on. Carrying of digits (e.g., from ones to tens, from tens to hundreds) may occur automatically when the user's tool is lifted from the interface at the end of addition of one set of digits, or may be manually invoked by terminating the addition of each set of digits in home area 110 or in a designated initial contact area (i.e., one of the initial contact areas 112a could be programmed as a “carry” control).

Other calculation or special modes may also be supported (e.g., multiplication, division, subtraction). Illustratively, a user may choose between multiple different special modes through some other input element of the device (e.g., a keypad) or may select a mode via the same touch screen on which the graphical user interface is displayed. For example, the touch screen may display a first interface (similar to or different from interface 102) to receive the user's selection of a mode of operation. Circle-spoke interface 102 (or other interface described herein) may then be displayed to facilitate the operation.

In another alternative embodiment of the invention, movement directly between digits' initial home areas may be interpreted differently, such as an abbreviated method of entering multiple basic data entry gestures. For example, without removing the tool from the interface after reaching home area 110 at the completion of a first data entry gesture corresponding to the first digit, the user may then proceed directly to the next digit's initial contact area 112, then the next digit's initial contact area, and so on (without returning to home area 110). Input may end when the tool is lifted.

Illustratively, the interface may be cued to accept movement directly between digits' initial contact areas when the user proceeded to the second digit's initial contact area after reaching home area 110 for the first time (i.e., instead of lifting the tool to complete the single-digit gesture).

Data entry via an interface such as circle-spoke interface 102 may be tied to a particular task or data field of a compatible application executing on the host device. In particular, the interface may be presented when numerical (or other) input is needed, and gestures made on the interface will be interpreted based on that task or data field. For example, if a three-digit number is expected, after three gestures (e.g., three single-digit data entry gestures) the application may accept the indicated value and automatically close the task, move to the next data field, or take other action.

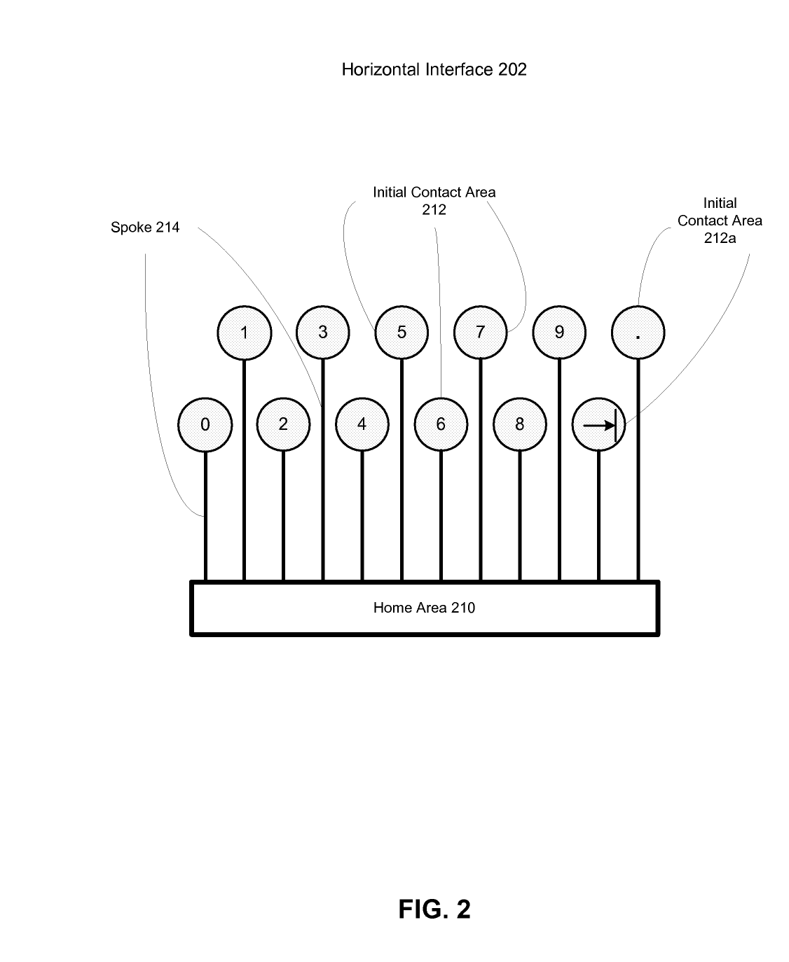

FIG. 2 demonstrates a user interface for facilitating data entry according to an embodiment of the invention. In this embodiment, horizontal interface 202 comprises a horizontal rectangular home area 210, with initial contact areas 212 aligned above the home area and coupled to the home area by spokes 214.

Gestures employed in circle-spoke 102 may also be employed with horizontal interface 202. Thus, a basic data entry gesture for a single character of input or a single command may comprise a touch within or near an initial contact area 212 and movement along the corresponding spoke 214 to or toward home area 210.

If direct movement is permitted between initial contact areas (e.g., for entering multiple consecutive characters), then initial contact areas 212 may be aligned differently to avoid requiring a user to trace over one initial contact area to reach another. For example, some digits may be positioned below or to either side of home area 210, or the digits may be distributed among more than 2 tiers.

In other embodiments of the invention, a linear or rectangular home area may be aligned vertically, diagonally or at yet some other angle. In yet other embodiments, a home area may comprise a different type of polygon, a curved shape, etc. Further, spokes may be arrayed in various fashions also, with different lengths (e.g., as in interface 202) and at different angles to a home area (e.g., as in interface 102), and need not be straight lines. The flexibility in size, shape and positioning of the home area, initial contact areas and spokes allows great variety in the design of the graphical user interface provided herein and the definition of gestures for using the interface.

Other gestures described above in conjunction with circle-spoke interface 102 of FIG. 1 may also be used with some adjustment with a rectangular interface or an interface having some other shape. For example, control gestures performed within home area 110 of FIG. 1, (e.g., by moving leftward or rightward) may be aligned for compatibility with the shape of the home area. Thus, while leftward and rightward gestures may still be made in home area 210 of FIG. 2, in an embodiment of the invention in which home area 210 is vertical rather than horizontal, leftward and rightward gestures may be changed to upward and downward (or vice versa).

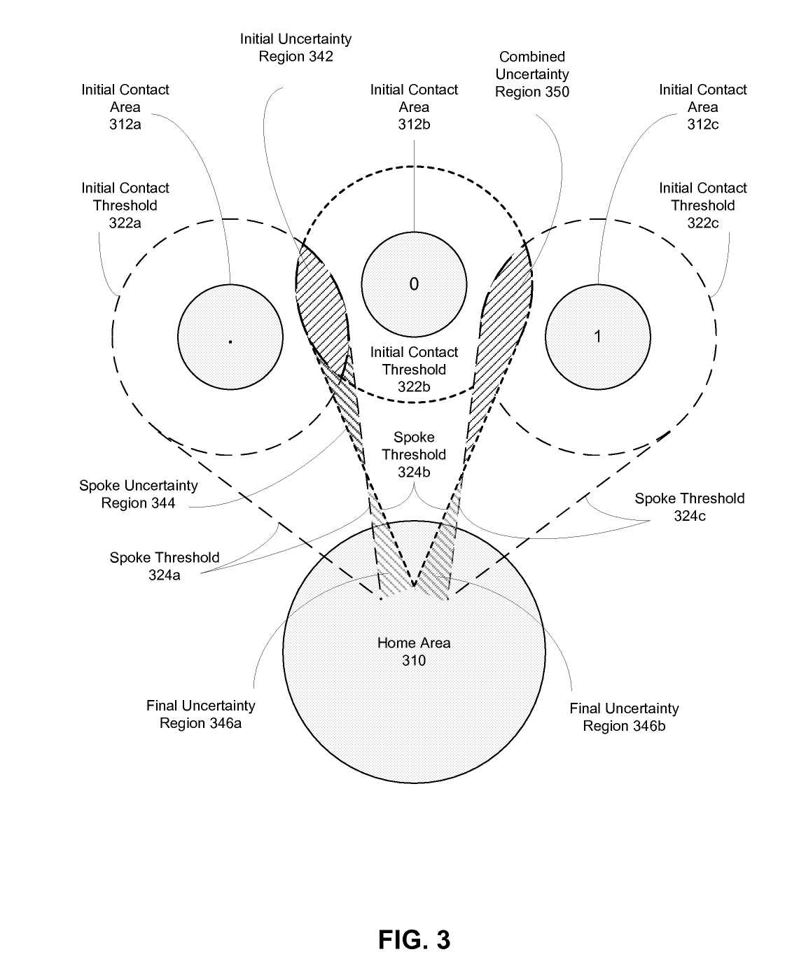

FIG. 3 is a diagram illustrating how touches and gestures on a touch screen may be interpreted according to an embodiment of the invention. In particular, FIG. 3 depicts illustrative regions of tolerance around initial contact areas and spokes (to enhance clarity the spokes themselves are not represented in FIG. 3). In this description, a region of tolerance around an initial contact area, spoke, home area or other element of an interface provided herein is a region within which a touch or part of a gesture may be imputed to that element.

Thus, initial contact thresholds 322a, 322b, 322c define regions within which an initial touch may be imputed to the corresponding initial contact area 312a, 312b, 312c. Similarly, spoke thresholds 324a, 324b, 324c define regions around spokes or preferred paths between an initial contact area 312 and home area 310, within which a touch or part of a gesture may be readily imputed to the corresponding spoke or path. Home area 310 may also have an associated region of tolerance.

It may be noted that initial contact thresholds 322 and/or spoke thresholds 324 may overlap, as exemplified by initial uncertainty region 342, spoke uncertainty region 344 and final uncertainty regions 346a, 346b (which may extend to cover all of home area 310 not part of the spoke threshold areas). Combined uncertainty region 350 merges an initial uncertainty region and a spoke uncertainty region. Note that uncertainty regions 342, 344 and 350 are associated with overlaps of adjacent thresholds, whereas final uncertainty regions 346a, 346b comprise areas between adjacent thresholds.

One of ordinary skill in the art will appreciate that in traditional touch screen interfaces, overlaps among data input areas are avoided because of the ambiguity that may arise when a user touches within the overlap area. However, in the illustrated embodiment of the invention, data entry depends on a user gesture that involves movement, and therefore ambiguities can be resolved by tracking the gesture.

For example, if a user touches within initial uncertainty region 342, it may be difficult to determine whether the user intended to enter the “.” symbol (associated with initial contact area 312a) or the “0” digit (associated with initial contact area 312b). However, the user's subsequent gesture, as he or she moves toward home area 310, will demonstrate his or her desire. If all or most of the gesture occurs within spoke threshold 324a, for example, the gesture will be interpreted as “.”; if all or most of the gesture occurs within spoke threshold 324b, the gesture will be interpreted as “0”.

It may be noted that in the illustrated implementation the cone-shaped spoke thresholds 324 do not extend to the center of home area 310 and that there is no overlap of spoke thresholds near the home area. This may facilitate the interpretation of gestures originating from home area 310 (such as the “throwing” gesture for deleting the last input) or wholly contained within the home area, as well as differentiating more clearly as to which spoke threshold a user's gesture was intended to traverse.

A portion of a threshold that is not part of a region of uncertainty may be considered a region of certainty, because a touch in such an area can generally be positively attributed to the corresponding contact area or spoke.

As described previously, a gesture may be interpreted as a particular character or other entry after the gesture is completed (e.g., from an initial contact area to the home area). In other embodiments, a gesture may be interpreted earlier, such as when there is little or no ambiguity or uncertainty about the desired input. Therefore, if a user touches within an initial contact threshold 322 that does not overlap a threshold associated with a different initial contact area, or when no more uncertainty regions exist between the current location of the user's touch and the home area, confidence in the user's desired data input may be high and the associated input may be entered.

In different embodiments of the invention, a gesture may therefore be interpreted based on different information. Information used to interpret a gesture may include the point of initial touch (e.g., where the user's tool contacts the touch screen at the beginning of the gesture), the point of final touch (e.g., the point at which the tool is removed from the touch screen), and a line segment between the points of initial and final touch (e.g., the slope of the line segment). From the initial and final points (x1,y1) and (x2,y2), the slope of the line segment may be computed as (y2−y1)/(x2−x1). In other embodiments other points along the path of movement of the tool may be considered, along with line segments between other points of the path.

Illustratively, if neither the starting nor ending point of a gesture lie within regions of uncertainty, interpretation of the gesture may be relatively simple. If one of the points lies within an area of uncertainty, then interpretation may depend on the threshold area(s) in which most of the gesture occurred, a slope of the path may be considered, or some other analysis may be performed. For example, the line segment or the slope of the line segment may be used to select which of two or more likely initial or final contact areas the user intended.

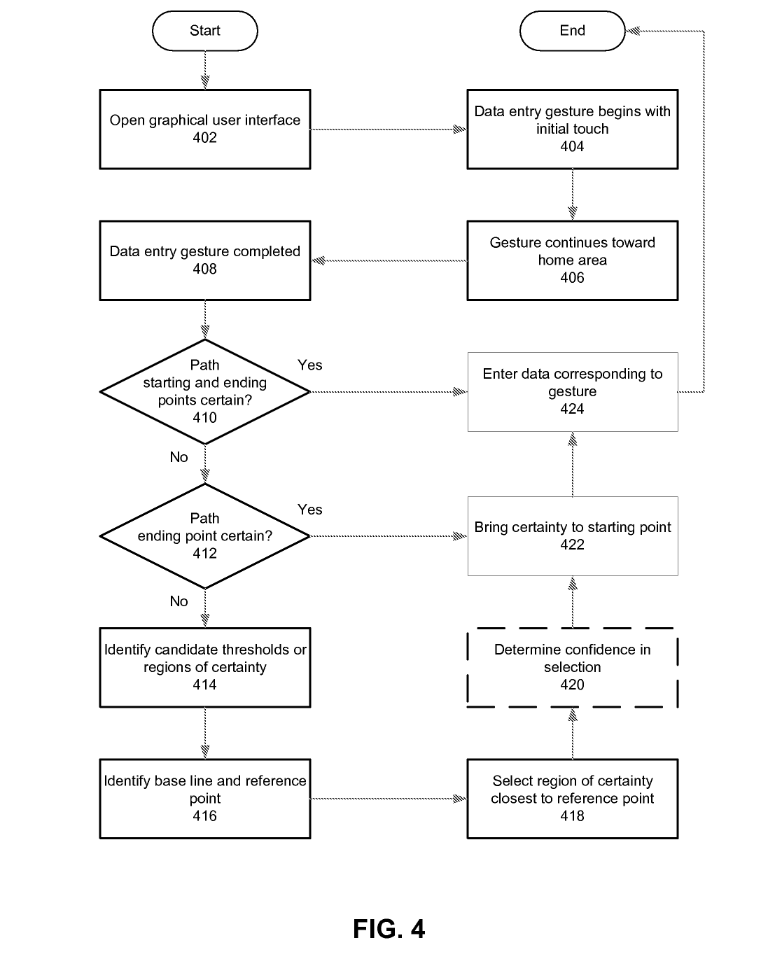

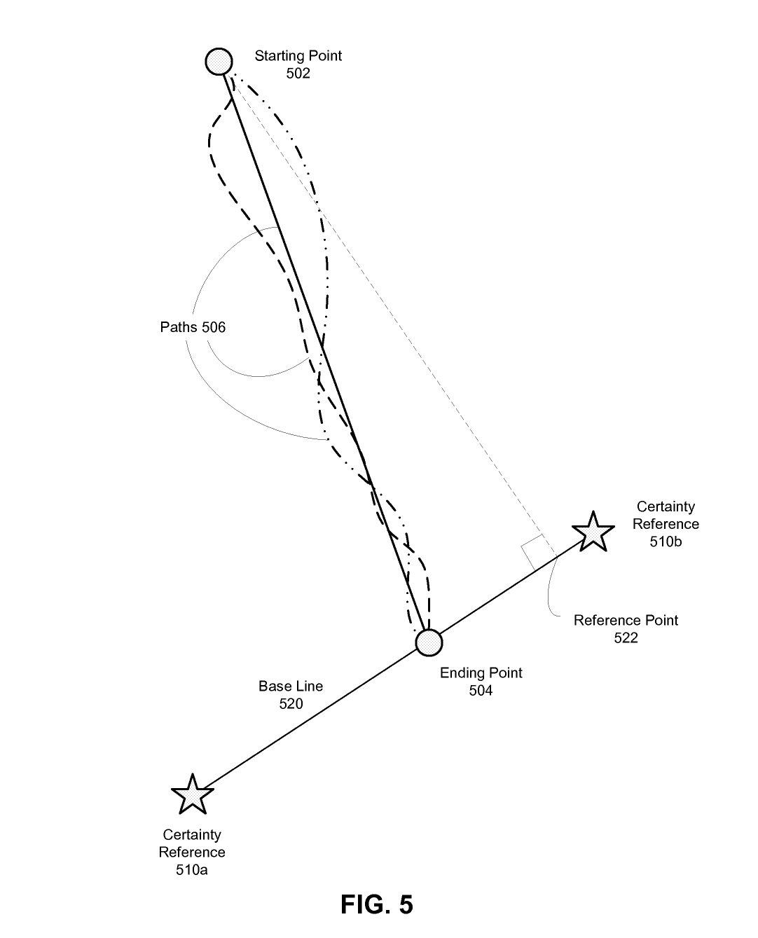

FIG. 4 is a flowchart demonstrating a method of receiving and interpreting a gesture on a spoke-based user graphical user interface, according to one embodiment of the invention. The following discussion may be better understood with reference to FIG. 5.

In operation 402, the interface is displayed for the user on his or her telephone, personal digital assistant or other communication or computing device having a touch screen or comparable touchable input component. The interface may be displayed only when input is needed from the user (e.g., to enter a telephone number, enter a username or password, select from multiple options, make a calculation) or may be a permanent or semi-permanent portion of the display.

In operation 404, the user begins a data entry gesture by touching a tool (e.g., a finger, a stylus) on or near an initial contact area. As described above in conjunction with FIG. 3, a threshold region of tolerance may be defined around an initial contact area so that the user need not touch directly on the desired initial contact area. The point at which the initial touch occurred is noted (e.g., in Cartesian coordinates, in relation to some reference point within the interface).

In operation 406, without lifting the tool from the touch screen, the user moves it toward a home area. The movement may more or less follow a spoke leading from the initial contact area to the home area—but need not be straight. The spoke may be non-linear, the user's tool may miss its mark, the device may be moved or bumped, or the path of movement may deviate from a direct course for some other reason without preventing proper interpretation of the gesture.

In one embodiment of the invention, if the tool is lifted from the surface of the touch screen during the gesture, the gesture is ended. If it cannot be readily interpreted (e.g., the gesture did not end in or near the home area), the gesture may be abandoned. By automatically ending the gesture when the tool is removed from the surface, gestures can be made in rapid sequence, as fast as the user is able to commence the next gesture.

In another embodiment of the invention, however, the tool may be momentarily lifted from the touch screen without ending the gesture (e.g., in case the user's hand or arm is bumped). The user may need to replace the tool near where it left the screen (e.g., within some region of tolerance) in order to be able to continue the gesture.

In operation 408, the user completes the gesture by lifting the tool at or near the home area, and the ending point of the gesture is recorded. In this embodiment of the invention completion of a data entry gesture causes the input of the data associated with the initial contact area, and may be distinguished from other gestures (e.g., to delete the previous input, advance to the next field, repeat a value, add digits).

In operation 410, the starting and ending points of the path traced by the tool are capture, as well as the path itself (e.g., some or all points of the path). If both the starting point and ending point of the path are within regions of certainty (e.g., within thresholds of initial and final contact areas but not within regions of uncertainty), the method advances to operation 424. Otherwise, the method continues with operation 412.

In operation 412, if the ending point of the gesture's path is certain (e.g., within a threshold but not within a region of uncertainty), the method advances to operation 422, otherwise it continues with operation 414.

In operation 414, the thresholds or regions of certainty that the user may have been aiming for with his or her gesture are identified. In particular, if the gesture ended in a region of uncertainty between two or more final contact areas or regions of certainty, those regions are identified. They may be represented by points, polygons or other suitable shapes, which may be termed certainty references because they represent regions of certainty.

For example, in FIG. 3, if a gesture ended in a final uncertainty region 346 it may be determined that the user probably intended to complete the gesture within either spoke threshold 324a or spoke threshold 324b, particularly within portions of those thresholds that overlap within the home area. The points at the end of the spoke thresholds, within home area 310, may be adopted as certainty references representative of the user's intended ending areas.

In other embodiments, the possible intended ending areas for the gesture may be represented by polygons surrounding geographic centers of those areas or other portions of the regions of certainty, by points corresponding to borders or other points of those regions of certainty closest to the actual ending point of the gesture, or by some other shape(s).

In one implementation of the illustrated embodiment of the invention, certainty references are statically derived for each area of uncertainty within the interface. In particular, each border of the area of uncertainty with a neighboring area of certainty is identified (e.g., borders between final uncertainty region 346a and spoke thresholds 324a, 324b in FIG. 3). One or more certainty references are then associated with individual points along each border.

In another implementation of this embodiment, certainty references are dynamically selected when a gesture ends in a region of uncertainty. In particular, the border points (of the ending region of uncertainty) that are closest to the ending point of the path of the gesture are identified and adopted as certainty references.

In other implementations, certainty references are selected in some other manner. For example, for a given region of uncertainty the midpoint of each border with a neighboring region of certainty may be adopted as a certainty reference. Or, lines tangent from one or more points along a gesture's path may be extended to find intersections with neighboring regions of certainty, and those points of intersection may be adopted as certainty references.

In operation 416, a base line connecting the certainty references is identified, along with a reference point within that line. The reference point is defined as the point at which a line that intersects the starting point of the gesture intersects the base line at a right angle.

In the illustrated embodiment of the invention, the base line intersects the ending point of the gesture. In other embodiments the base line may intersect the gesture at some other point, or may not intersect the gesture's path at all—in which case a point along the base line may be adopted as a projection of the end point of the path.

In operation 418, the certainty reference closest to the reference point is selected and assumed to represent the region of certainty or final contact area that the user targeted. It can be seen that this is the region toward which the gesture was generally directed even if it turns out that the selected certainty reference is not the closest certainty reference to the end point of the gesture.

In optional operation 420, the confidence of the selection is derived from the distance between the reference point and the selected certainty reference. In particular, the level or amount of confidence is proportional to the distance between the selected certainty reference and the reference point.

In an embodiment of the invention, if the level of confidence is not high enough the selection of a certainty reference may be disregarded and the gesture may be abandoned. The user may be required to perform a new gesture if he or she wishes to use the interface to input a data value.

In operation 422, the starting point of the gesture is associated with a region of certainty or initial contact area. In the illustrated embodiment of the invention, this procedure may be similar to that conducted in operations 414 through 420 to bring certainty to the ending point of the gesture. In particular, certainty references representing the possible starting regions of certainty or initial contact areas are selected, a base line connecting those references is constructed, a reference point along the base line is identified and the direction of the gesture's starting point from that reference point is determined.

In operation 424, the data associated with a gesture commencing at the selected initial contact area and ending at the selected final contact area is entered. If there is no data associated with this gesture (e.g., if the gesture is not a recognized gesture), it may be abandoned and the user may need to commence a new gesture if he or she wishes to enter data via the interface.

If a starting or ending point of a gesture could be attributed to any of three or more regions of certainty, instead of just two as described in FIG. 4, the procedure described above could be performed sequentially for each pair of regions to determine which region is most appropriate, or the gesture could be rejected (e.g., and the user prompted to try again). However, in embodiments of the invention described herein, the interface and useful gestures can be configured or reconfigured to reduce the likelihood of a user tracing a path between two points that are each surrounded by three or more regions of uncertainty.

FIG. 5 graphically represents the selection of one region of certainty over another when a gesture begins and/or ends in a region of uncertainty adjacent to two regions of certainty.

Starting point 502 is the starting point of a gesture and ending point 504 is the ending point of a gesture. Paths 506 represent various possible paths of a gesture from starting point 502 to ending point 504.

Certainty references 510 (i.e., references 510a, 510b) represent final contact areas, spokes or portions of thresholds around final contact areas or spokes that are not part of regions of uncertainty.

Base line 520 connects certainty references 510, and reference point 522 is the point at which a line perpendicular to the base line and intersecting starting point 502 intersects the base line.

In one embodiment of the invention, a user may program an initial contact area to associate it with a particular data value, character, code, command or other input. This programming may occur before the interface is presented, or may be performed after the interface is displayed. For example, by tapping some number of times on the desired initial contact area (e.g., 2, 3), or by activating a control or performing some other gesture (e.g., moving from the desired initial contact area to the home area and back to the initial contact area), a programming mode of operation may be initiated. The user may then select the input to be associated with the chosen initial contact area.

Also, in different embodiments of the invention, initial contact areas, a home area, spokes and other elements of a user interface according to the present invention may have various shapes, sizes, colors and/or other attributes. The embodiments described herein are not intended as limitations, but rather to enhance the clarity of the illustrations and promote their understanding.

A graphical user interface or method of using a graphical user interface described herein may be incorporated into a device such as a telephone, personal digital assistant, portable computer or other device that uses a touch screen or comparable touch-sensitive input component instead of or in addition to a more traditional input component having multiple independently manipulable keys, buttons or other elements. The device may also include one or more programs for displaying the graphical user interface, interpreting gestures, using data input via the gestures, and so on.

The environment in which a present embodiment of the invention is executed may incorporate a general-purpose computer or a special purpose device such as a hand-held computer. Details of such devices (e.g., processor, memory, data storage, display) may be omitted for the sake of clarity.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code and/or data, which can be stored in a computer-readable storage medium as described above. When a computer system reads and executes the code and/or data stored on the computer-readable storage medium, the computer system perform the methods and processes embodied as data structures and code and stored within the computer-readable storage medium.

Furthermore, the methods and processes described below can be included in hardware modules. For example, the hardware modules may include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

What is claimed is:

1. A graphical user interface for facilitating data entry on a touch screen, the graphical user interface comprising:
multiple initial contact areas, each initial contact area being associated with a data input;
a home area; and
for each said initial contact area, a corresponding spoke between said initial contact area and said home area;
wherein the data input associated with a first initial contact area is entered in response to a first gesture from the first initial contact area to said home area.

2. The graphical user interface of claim 1, wherein said first gesture comprises:
contact of a tool with the touch screen in proximity to the first initial contact area; and
movement of the tool on the touch screen in a direction of said home area, in proximity to said corresponding spoke.

3. The graphical user interface of claim 2, wherein said first gesture further comprises:
removal of the tool from the graphical user interface at said home area.

4. The graphical user interface of claim 2, wherein said first gesture further comprises:
removal of the tool from the graphical user interface at said home area.

5. The graphical user interface of claim 1, wherein a given spoke is connected to one or more of said corresponding initial contact area and said home area.

6. The graphical user interface of claim 1, wherein a second gesture for deleting a previous data input comprises:
contact of a tool on the touch screen in said home area; and
movement of the tool on the touch screen away from said home area.

7. The graphical user interface of claim 6, wherein said second gesture for deleting a previous data input further comprises:
movement of the tool on the touch screen away from said home area toward said initial contact area associated with the previous data input.

8. The graphical user interface of claim 1, wherein a second gesture for adding data inputs associated with a second and third initial contact areas comprises:
contact of a tool on the touch screen in proximity to the second initial contact area; and
movement of the tool on the touch screen to the third initial contact area.

9. A method of facilitating data entry with a graphical user interface comprising multiple initial contact areas, a home area and spokes extending between the home area and each of the multiple initial contact areas, the method comprising:
detecting a first gesture comprising:
contact of a tool on a touch screen on which the graphical user interface is displayed, in proximity to a first initial contact area associated with a first data input; and
movement of the tool on the touch screen from the first initial contact area in a direction of said home area, in proximity to a first spoke; and
entering the first data input in response to said first gesture.

10. The method of claim 9, wherein said first gesture further comprises:
removal of the tool from contact with the touch screen at the home area.

11. The method of claim 9, wherein said first gesture further comprises:
removal of the tool from contact with the touch screen near the home area.

12. The method of claim 9, further comprising detecting a second gesture for deleting a previous data input, said second gesture comprising:
contact of the tool on the touch screen in the home area; and
movement of the tool on the touch screen away from the home area.

13. The method of claim 12, wherein said second gesture for deleting a previous data input further comprises:
movement of the tool on the touch screen away from the home area toward an initial contact area associated with the previous data input.

14. The method of claim 9, further comprising detecting a second gesture for adding data inputs associated with a first and second initial contact areas, said second gesture comprising:
contact of a tool on the touch screen in proximity to the first initial contact area; and
movement of the tool on the touch screen to the second initial contact area.

15. The method of claim 14, wherein said second gesture further comprises:
removal of the tool from contact with the touch screen at the second initial contact area.

16. A computer-readable medium storing instructions that, when executed by a computer, cause the computer to perform a method of facilitating data entry with a graphical user interface comprising multiple initial contact areas, a home area and spokes extending between the home area and each of the multiple initial contact areas, the method comprising:
detecting a first gesture comprising:
contact of a tool on a touch screen on which the graphical user interface is displayed, in proximity to a first initial contact area associated with a first data input; and
movement of the tool on the touch screen from the first initial contact area in a direction of said home area, in proximity to a first spoke; and
entering the first data input in response to said first gesture.
